(19) United States
(12) Patent Application Publication
(10) Pub. No.: US 2003/0164349 A1
(43) Pub. Date: Sep. 4, 2003

(54) Control system for controlling a hoist

(75) Inventor: Thomas Kohlenberg, Soest (DE)

Correspondence Address: HENRY M FEIEREISEN, LLC, 350 FIFTH AVENUE, SUITE 4714, NEW YORK, NY, 10118, US

(73) Assignee: DEMAG CRANES & COMPONENTS GMBH, Wetter (DE)

(21) Appl. No.: 10/370,303

(22) Filed: Feb. 18, 2003

(30) Foreign Application Priority Data
Feb. 21, 2002 (DE) 102 07 880.7

(51) Int. Cl. B66C 13/12

(52) U.S. Cl. 212/284

(57) ABSTRACT

A control system includes an intuitively working remote control operating unit which has a first pair of control elements for controlling a movement of a hoist, in particular a trolley of a crane, in two opposite movement directions along an axis. One control element is assigned separately to one movement direction and the other control element assigned separately to the other opposite movement direction. The control elements are so disposed as to form a side-correct representation of the movement directions, wherein assignment of the control elements to the movement directions corresponds to an orientation of the operating unit in relation to a directed external field and is swapped, when the operating unit is oriented in opposite direction.

### CROSS-REFERENCES TO RELATED APPLICATIONS

This application claims the priority of German Patent Application, Serial No. 102 07 880.7, filed Feb. 21, 2002, pursuant to 35 U.S.C. 119(a)-(d), the disclosure of which is incorporated herein by reference.

### BACKGROUND OF THE INVENTION

The present invention relates, in general, to a control system for controlling a hoist.

German Pat. No. DE 42 17 989 A1 describes a control system for mobile use in the work area of a hoist. Transverse movements of a trolley of the hoist are effected by two control elements in the form of operating knobs in side-by-side disposition. When the operator stands with the control system in front of the hoist, actuation of the right operating knob results, from the perspective of the operator, in a trolley movement to the right while actuation of the left operating knob results, .from the perspective of the operator, in a trolley movement to the left. In order to ensure an intuitive operation of the trolley, even when the operator is positioned at a different relationship to the hoist, the orientation of the control system to the hoist is ascertained and used to swap the function of both operating knobs, when the control system changes the position vis-à-vis the hoist. Hereby, the control system includes two direction-dependent receivers which receive from antiparallel directions different optical signals which are distinctively encoded. The signal sources for the optic signal are fixedly attached to the hoist and oriented, i.e. relative to the transmission direction of the coded signals sent out from the signal source, in parallel relationship to the movement axis of the transverse movement of the trolley of the hoist. The receivers mounted to the control system respectively receive the coded signals and ascertain from the coding of the signals the information whether the control system is positioned together with the operator in a first or in an opposite second orientation relative to the hoist. Depending on this information, the operating knobs are automatically switched over in the control system.

This conventional control system suffers shortcomings because the functional switchover requires a visual connection between the receivers and the transmitters so that the switchover and thus the operation of the control system are limited to the area between both transmitters.

It would therefore be desirable and advantageous to provide an improved control system which obviates prior art shortcomings and which is effective and intuitively operative without limitation.

### SUMMARY OF THE INVENTION

According to one aspect of the present invention, a control system includes an intuitively working remote control operating unit having a first pair of control elements for controlling a movement of a hoist, in particular a trolley of a crane, in two opposite movement directions along an axis, with one control element assigned separately to one movement direction and the other control element assigned separately to the other opposite movement direction, wherein the control elements are so disposed as to form a side-correct representation of the movement directions, and wherein assignment of the control elements to the movement directions corresponds to an orientation of the operating unit in relation to a directed external field and is swapped, when the operating unit is oriented in opposite direction.

The present invention resolves prior art problems by correlating the assignment of the control elements to the movement directions in dependence on the orientation of the operating unit relative to the direction of the external field. In this way, the need for a visual connection to stationary transmitters or receivers is eliminated because the assignment of the control elements is simply swapped, when the orientation of the operating unit is reversed.

According to another feature of the present invention, the external field may be a magnetic field and the operating unit may include an electronic compass for ascertaining the orientation of the operating unit relative to the magnetic field. In this way, the operating unit has a robust, light and compact design. Suitably, the earth's magnetic field can be used as the magnetic field so that the provision of a separate device to produce a magnetic field can be omitted.

According to another feature of the present invention, the operating unit may have a vertical grip zone for arrangement of a second pair of control elements in vertical spaced-apart relationship for controlling lifting and lowering movements of the hoist. Thus, the control elements are arranged in analogy to the hoist movement, whereby the lower control element is assigned to a lowering of the hoist and the upper control element is assigned to a lifting of the hoist.

According to another feature of the present invention, the magnetic field direction and the orientation of the operating unit relative to the hoist define an angle which is stored in the operating unit through execution of a calibrating function, wherein a memorized function in the operating unit can be activated, when the operating unit is pivoted in a defined orientation relative to the hoist. As a result, the operating unit can be swiftly put to service.

In the event, the operating unit has several pairs of control elements for controlling a movement of the hoist in opposite movement directions along further axes, the hoist movement along several movement axes can be carried out by a single operator. The likelihood of operating errors can be reduced, when the pairs of control elements for movement in opposite movement directions along one axis are operated by a common rocker-like operating element to thereby allow the intuitive operation in the opposite movement directions. The risk of operating errors can be further decreased, when at least two pairs of control elements control a movement of the hoist along two axes in orthogonal relationship, whereby the at least two pairs of control element are also disposed in orthogonal relationship.

According to another feature of the present invention, there may be provided a mechanism for automatically realizing the side-correct assignment of the control element with respect to the movement directions. In this way, the need for a manual switchover is eliminated.

According to another feature of the present invention, the operating unit may include a signaling unit for outputting a message and/or a functional locking mechanism for suppressing operation of the operating unit, when the assignment of at least one control element relative to a movement direction is not or no longer unambiguously clear. Thus, operating errors are avoided, when the operating unit is oriented indiscriminately. The message can be ascertained even at most unfavorable ambient conditions, when the signaling unit includes an optical device and/or acoustic device and/or tactile device.

According to another feature of the present invention, the operating unit may have a unit for wireless control of the hoist. In the way, the mobility of the operator is not limited by the use of connection cables.

According to another feature of the present invention, the operating unit may be used for moving a trolley of a moveable bridge crane and includes an operating element which may be configured to resemble a schematic bridge crane. Thus, the assignment of the control elements to the movement directions can easily be determined.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top perspective view of a bridge crane with pertaining control system according to the present invention;

FIG. 2 is a schematic illustration of a circle diagram depicting the orientation of an operating unit of the control system relative to the bridge crane;

FIG. 3 is a front and bottom perspective view of the operating unit; and

FIG. 4 is a schematic block diagram to show the relationship of components of the control system.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

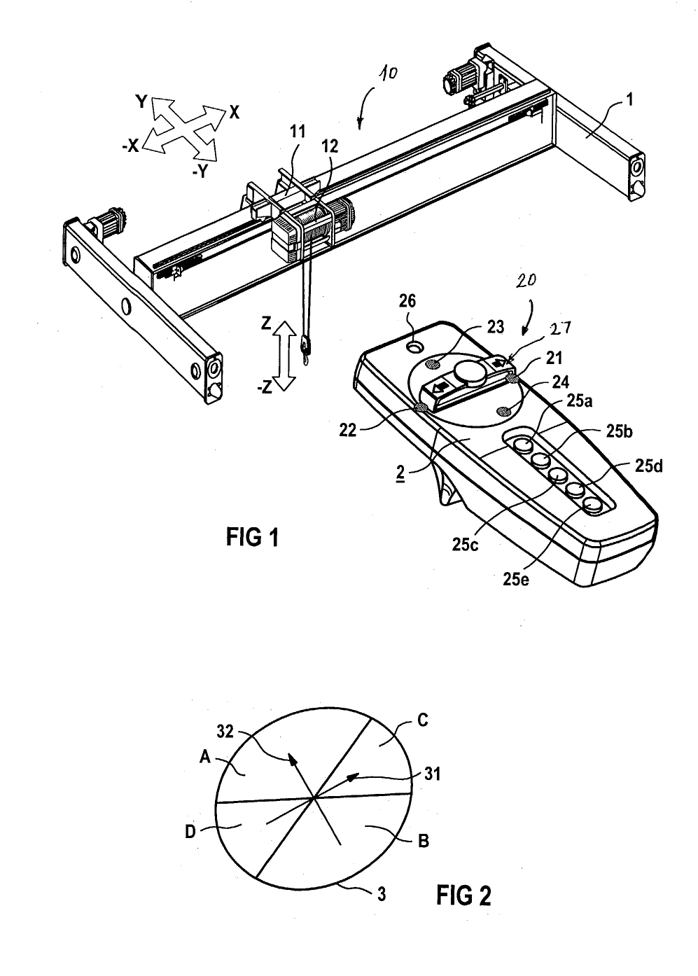

Turning now to the drawing, and in particular to FIG. 1, there is shown a top perspective view of an overhead or bridge crane, generally designated by reference numeral 10 and movable in a direction to coincide with the y-axis of the Cartesian coordinate system. The bridge crane 10 includes a bridge 1, which spans a job site, and a trolley-mounted hoisting mechanism, which includes a trolley 11 and a hoist 12. The trolley 1 1 is intended for travel in transverse direction with respect to the y-axis (longitude travel) to coincide with the x-axis of the Cartesian coordinate system. The x-axis and y-axis are ordinarily assumed to define a generally horizontal plane. The hoist 12 includes essentially a cable winch for lifting and lowering a load (not shown) in vertical direction which is in alignment with the z-axis which is normal to the y-axis and x-axis.

The movements in the x-axis, y-axis and z-axis are realized by respective electric motors (not shown) which are activated by a suitable crane control mechanism that is part of a control system according to the present invention, generally designated by reference numeral 20 and including a mobile operating unit 2 which communicates with a radio receiver of the crane control mechanism for receiving signals transmitted by the operating unit 2.

The operating unit 2 has a topside provided with an operating knob 27 which is movable crosswise for actuation of control elements 21, 22, 23, 24 integrated in the operating unit 2. The disposition of the control elements 21, 22, 23, 24 is depicted in FIG. 1. Of the control elements 21, 22, 23, 24, the control elements 21, 22 form a first pair to implement a to-and-fro movement of the trolley 11 in x-direction. The control elements 23, 24 form a second pair whereby a forward deflection of the operating knob 27 toward the control element 23 results in a movement of the bridge crane 10 in positive y-direction, and a rearward deflection of the operating knob 27 toward the control element 24 results in a movement of the bridge crane 10 in negative y-direction. The activation of the control elements 21, 22, 23, 24 is infinitely variable, whereby an increase in deflection or operating force of the operating knob 27 toward the control elements 21, 22, 23, 24 results in a speed-up in movement of the bridge crane 1 or the trolley 11, respectively.

The operating unit 2 is designed to allow an operator to guide it with one hand and is normally pointed during operation toward the bridge crane 1 and the trolley 11. The operating unit 2 can be operated intuitively, i.e., for example, a movement of the operating knob 27 to the right toward the control element 21 results in a movement of the trolley 11 in x-direction which, in the illustration of FIG. 1 and from a viewpoint of the operator, also causes a movement of the trolley 11 to the right. Likewise, actuation of the operating knob 27 in a direction to the other control elements 22, 23, 24 results in each case to a movement of the trolley 11 or bridge crane 1 in the one direction that coincides with the movement of the operating knob 27 as executed by the operator.

In the event the operator moves the operating unit 2 to the other side of the bridge crane 10, the operating unit 2 aligns itself in the direction of the bridge crane 10 and trolley 11 for control of the movements. In order to enable an intuitive operation of the bridge crane 10 and trolley 11 with the operating knob 27 of the operating unit 2 also in this case, the control functions assigned to the control elements 21, 22 are automatically swapped, as are the control functions, assigned to the control elements 23, 24, which are also automatically swapped. Thus, for example, a deflection of the operating knob 27 to the right toward the control element 21 causes the trolley 11 to now move in negative x-direction, i.e. also to the right from a viewpoint of the operator. A deflection of the operating knob 27 to the left toward the control element 22 causes the trolley 11 to move in positive x-direction, i.e. also to the left. A forward deflection of the operating knob 27 toward the control element 23 causes the bridge crane 10 to move in negative y-direction, i.e. also forward, whereas a rearward deflection of the operating knob 27 toward the control element 24 causes the bridge crane 10 to move in positive y-direction, i.e. also rearward.

Thus, the functions of the control elements 21, 22, 23, 24 are established in dependence on the orientation of the operating unit 2 relative to the bridge crane 10. The swap or switchover in y-direction (longitude travel) is implemented analog to a swap in x-direction (transverse travel). It will be understood that the terms “swap” and “switchover” are used synonymous in the disclosure to refer to the exchange of control function between control elements for movement along the pertaining axis.

FIG. 2 shows a schematic illustration of a diagram of a circle 3 depicting the orientation of the operating unit 2 relative to the bridge crane 10. Arrow 31 symbolizes hereby a movement direction of the trolley 11 in positive x-direction. Arrow 32 symbolizes the orientation of the operating unit 2, with the orientation coinciding with a deflection of the operating knob 27 toward the control element 23. The orientations, symbolized by the arrows 31, 32, correspond to the position of the operating unit 2 according to FIG. 1. In this position, arrow 32 points to sector A of the full circle 3.

In the event the operator moves the operating unit 2 clockwise around the bridge crane 10, the arrow 32, which symbolizes the orientation of the operating unit 2, shifts in the circle diagram also clockwise and points hereby in succession to sectors A, C, B and finally D. As long as the arrow 32 points to sector A, the orientation of the operating unit 2 relative to the bridge crane 10 corresponds essentially to the initial position, shown in FIG. 1, so that a switchover of the control functions of the control elements 21, 22; 23, 24, as described above, is not yet required. When the operator has moved the operating unit 2 around the bridge crane 10 far enough that the arrow 32 points to sector B, the functions of the control elements 21, 22, 23, 24 are swapped to maintain the intuitive operation, as described above.

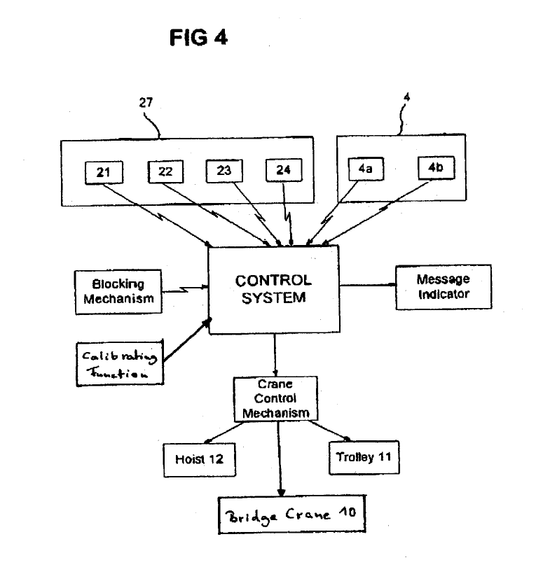

When the arrows points to sectors C, D, which are positioned between the sectors A, B, the operating unit 2 is aligned in substantial parallel relationship to the movement direction of the trolley 11 in x-direction. In order to prevent faulty operation in these situations, the execution of control functions of the operating unit 2 is suppressed. This blocking action of the control functions is signaled by a warning lamp 26. Thus, even when actuating the operating knob 27 in these situations, no control function is executed, and a warning sound is triggered. Optionally, the operating unit 2 may also include a vibrating message indicator to additionally notify the operator of the suspension of any control functions. Through a simple twist of the wrist joint, the proper orientation of the operating unit 2 with respect to the bridge crane 10 can be re-established to activate the control functions again. FIG. 4 shows by way of a schematic block diagram the relationship of components of the control system.

The operating unit 2 includes an electronic compass (not shown) which transmits information to an evaluation assembly of the control system about the orientation, i.e. angular disposition, of the operating unit 2 relative to a magnetic field, e.g. the earth's magnetic field. Structure and mode of operation of such an electronic compass is generally known to the artisan and thus is not described in more detail for the sake of simplicity.

Stored in the evaluation assembly is the information about the switchover angles when a swap has to occur in correspondence with the operational states associated to the sectors A, B, C, D. These switchover angles may be permanently stored or, as here, inputted by the operator of the operating unit 2. In any event, at least when the operating unit 2 is used for the first time, the evaluation assembly must be provided with a starting value because the orientation of the bridge crane 10 in the earth's magnetic field, i.e. the orientation of the arrow 31, can differ from job site to job site. Thus, the operating unit 2 includes a calibrating key 25a which is actuated for implementing a basic setting when the operating unit 2 is disposed in a defined orientation relative to the bridge crane 10. This orientation is here the orientation shown in FIG. 1.

On the basis of this set starting value, also called offset value, and the angle measured by the electronic compass, the evaluation assembly calculates the angle between the orientation of the operating unit 2 and the orientation of the bridge crane 10, i.e. between arrow 32 and arrow 31. The relationship between the offset value and the switchover angles are set permanently in the operating unit 2 so that the switchover angles are established once the offset value is programmed. On the basis of the angle and the switchover angles, the evaluation assembly switches the operating unit 2 respectively. Of course, other operating procedures for setting the offset value are conceivable as well, without departing from the spirit of the present invention. Even a manual modification of the switchover angles, instead of the exploitation of the fixed switchover angles, may be carried out.

Further keys 25b, 25c, 25d, 25e on the topside of the operating unit 2 are used for initiating an emergency function and other special functions.

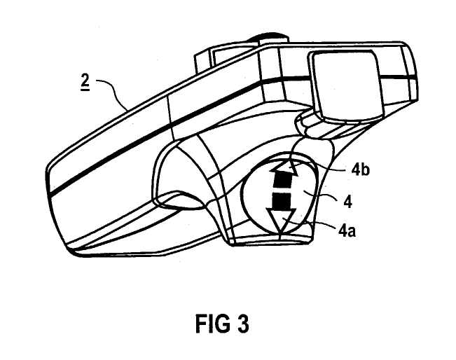

Turning now to FIG. 3, there is shown a front and bottom perspective view of the operating unit 2. As is shown in FIG. 3, the operating unit 2 includes a control switch 4 which projects downwards form the operating unit 2 in vertical direction and is of rocking design, for control of the hoist 12. The control switch 4 has an upper control element 4a and a lower control element 4b, whereby deflection in the direction toward the upper control element 4b causes a lifting of the load whereas a deflection toward the lower part 4b causes a lowering of the load. In this way, the movement in z-direction is also carried out intuitively. Unlike the control element pairs 21, 22; 23, 24, there is, however, no need to swap the control elements 4a, 4b, when the operator moves the operating unit 2 to the other side of the bridge crane 10.

While the invention has been illustrated and described in connection with currently preferred embodiments shown and described in detail it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A control system, comprising an intuitively working remote control operating unit having a first pair of control elements for controlling a movement of a hoist, in particular a trolley of a crane, in two opposite movement directions along an axis, with one control element assigned separately to one movement direction and the other control element assigned separately to the other opposite movement direction, wherein the control elements are so disposed as to form a side-correct representation of the movement directions, and wherein assignment of the control elements to the movement directions corresponds to an orientation of the operating unit in relation to a directed external field and is swapped, when the operating unit is oriented in opposite direction.

2. The control system of claim 1, wherein the external field is a magnetic field, and wherein the operating unit includes an electronic compass for ascertaining the orientation of the operating unit relative to the magnetic field.

3. The control system of claim 2, wherein the magnetic field is the earth's magnetic field.

4. The control system of claim 1, wherein the operating unit has a vertical grip zone for arrangement of a second pair of control elements in vertical spaced-apart relationship for controlling lifting and lowering movements of the hoist.

5. The control system of claim 2, wherein the magnetic field direction and the orientation of the operating unit relative to the hoist define an angle which is stored in the operating unit through execution of a calibrating function, and wherein a memorized function in the operating unit is activated when the operating unit is pivoted in a defined orientation relative to the hoist.

6. The control system of claim 1, wherein the operating unit has additional pairs of control elements for controlling movements of the hoist in opposite movement directions along further axes.

7. The control system of claim 6, wherein the pairs of control elements for movement in opposite movement directions along further axes are operated by a common rocker-like control element to thereby allow the intuitive operation in the opposite movement directions.

8. The control system of claim 6, wherein at least two pairs of control elements control a movement of the hoist along two axes in orthogonal relationship, whereby the at least two pairs of control elements are also disposed in orthogonal relationship.

9. The control system of claim 1, and further comprising means for automatically realizing the side-correct assignment of the control element relative to the movement directions.

10. The control system of claim 10, wherein the operating unit includes at least one of a signaling unit for outputting a message and a blocking mechanism for suppressing operation of the operating unit, when the assignment of at least one control element relative to a movement direction is no longer unambiguously clear.

11. The control system of claim 10, wherein the signaling unit includes at least one messaging device selected from the group consisting of optical device, acoustic device and tactile device.

12. The control system of claim 1, wherein the operating unit has means for wireless control of the hoist.

13. The control system of claim 1, wherein the operating unit is used for moving a trolley of a moveable bridge crane, and has an operating element configured to resemble a schematic bridge crane.
